(19) United States
(12) Patent Application Publication
(10) Pub. No.: US 2026/0092175 A1
(43) Pub. Date: Apr. 2, 2026

(54) RESIN COMPOSITION, ARTIFICIAL NAIL AND PREPARATION METHOD THEREOF

(71) Applicant: Yong Chen, Xinyang (CN)

(72) Inventor: Yong Chen, Xinyang (CN)

(21) Appl. No.: 19/411,181

(22) Filed: Dec. 6, 2025

Related U.S. Application Data
(63) Continuation of application No. PCT/CN2024/101573, filed on Jun. 26, 2024.

(30) Foreign Application Priority Data
Mar. 11, 2024 (CN) 202410276250.1

(51) Int. Cl. C08L 75/04; A45D 31/00; C08K 5/07; C08K 5/101; C08K 5/5397

(52) U.S. Cl. CPC C08L 75/04; A45D 31/00; C08K 5/07; C08K 5/101; C08K 5/5397

(57) ABSTRACT

Disclosed are a resin composition, an artificial nail and a preparation method thereof. The resin composition includes following components: a first component including a UV/moisture dual-curable resin, where the UV/moisture dual-curable resin has a hydroxyl group; a second component including a UV curable resin, where the UV curable resin has an isocyanate group; and a photoinitiator. The artificial nail prepared from the resin composition disclosed herein can be preformed and have a weak foreign body sensation, thereby meeting different needs of users. Moreover, since the resin composition contains two or more resin components, the hardness and softness of the artificial nail can be adjusted by changing types and contents of resin components.

### CROSS-REFERENCE TO RELATED APPLICATIONS

The present application is a Continuation Application of PCT application No. PCT/CN2024/101573 filed on Jun. 26, 2024, which claims the benefit of Chinese Patent Application No. 202410276250.1 filed on Mar. 11, 2024. The contents of the above-identified applications are hereby incorporated by reference.

### TECHNICAL FIELD

The present disclosure relates to a resin composition, an artificial nail and a preparation method thereof, belonging to the field of artificial nails.

### BACKGROUND

With the growing popularity of nail art such as decorating fingernails or toenails with small artificial gemstones, drawing designs, sticking stickers, and applying artificial nails on fingernails or toenails, nail cosmetic materials and nail art techniques using the same are developing rapidly. Manicure is mainly performed by applying pigments in a nail polish with various colors to fingernails or toenails. However, this method of applying liquid pigments requires a long drying time after applying the pigments and has poor durability after drying, thus causing inconvenience to users.

In recent years, a nail cosmetic material using a photocurable resin composition (so-called gel nail) has attracted much attention since the photocurable resin composition does not contain an organic solvent, can be cured in a short time, and has excellent coating thickness and glossiness. The gel nail is mainly composed of a polymer or an oligomer, a monomer, and a photopolymerization initiator. The gel nail is applied on a nail surface and irradiated with an ultraviolet (UV) exposure machine or a light emitting diode (LED) exposure machine as a light source to form a cured coating film.

A photocurable resin composition for forming a photocurable resin layer is applied to a natural nail, then curing by an ultraviolet (UV) exposure machine or a light emitting diode (LED) exposure machine to form the photocurable resin layer. And, the photocurable resin layer has many advantages, such as softness, fineness, difficulty in being broken, no discoloration when exposed to the sun, and outstanding gloss.

However, after directly forming a photocurable resin layer on a natural nail, if a photocurable resin layer, directly formed on a natural nail, needs to be removed, a finger should be soaked in a harmful solution for a long time, which is not only very harmful to skins and nails, and there is a problem that the natural nail may be seriously damaged after the photocurable resin layer is removed.

The cited reference 1 discloses a gel nail sticker including: a lower laminated part which is a part directly attached to a nail or a toenail, and has a color or a pattern, and is formed of a flexible material to correspond to a curved surface of the nail or the toenail; and an upper laminated part which is a transparent coated layer positioned on the lower laminated part and providing glossiness to a color or a pattern of the lower laminated part, and is in a flexible semi-solid state to correspond to the curved surface of the nail or the toenail before being attached to the nail or the toenail, and is cured to a solid state while maintaining a form attached to the nail or the toenail when an ultraviolet ray is irradiated to the upper laminated part after the upper laminated part is attached to the nail or the toenail. However, the hardness of the gel nail sticker is relatively high. Since shapes and curvatures of human nails are inconsistent, the gel nail sticker does not fit well with human nails, and there is a strong foreign body sensation when using the same. Furthermore, the gel nail sticker is a flat product, requiring the wearer to adjust the shape and strength by oneself when using the same, resulting in poor use effect.

Existing photocurable nail stickers generally achieve a first cure by means of a resin and a curing agent. Since this curing method contains only one resin, only a limited number of resin components can be selected to adjust the hardness and softness of the nail sticker.

Therefore, the development of an artificial nail that can be preformed and has a weak foreign body sensation and can flexibly adjust the hardness and softness has become a technical problem that needs to be solved urgently.

### The Cited Reference

Cited reference 1: CN 107690292A.

### SUMMARY

### Problems to be Solved by the Present Disclosure

In view of technical problems existing in the prior art, the present disclosure first provides a resin composition, which can be used to prepare an artificial nail. The prepared artificial nail can be preformed and has a weak foreign body sensation.

Further, the present disclosure also provides a method for preparing an artificial nail, which is simple and easy to implement. Raw materials of the artificial nail are easy to obtain, and the artificial nail is suitable for mass production.

### Solutions for Solving Problems

In one aspect, a resin composition is provided, including following components:
a first component including a UV/moisture dual-curable resin, wherein the UV/moisture dual-curable resin has a hydroxyl group;
a second component including a UV curable resin, wherein the UV curable resin has an isocyanate group; and
a photoinitiator.

In some such resin compositions, a hydroxyl value of the first component is 52-110 mgKOH/g; and/or a mass percentage of the isocyanate group in the second component is 11.8%-13.8%.

In some such resin compositions, a mass percentage of the first component is 25%-65%, a mass percentage of the second component is 15%-45%, and a mass percentage of the photoinitiator is 2%-5%.

In some such resin compositions, a third component is further included, and the third component includes a polycaprolactone polyol; optionally, a hydroxyl value of the polycaprolactone polyol is 54-98 mgKOH/g; optionally, based on a total mass of the resin composition being 100%, a mass percentage of the polycaprolactone polyol is 5%-30%.

In some such resin compositions, the resin composition further includes one or a combination of two or more of the group consisting of a diluent, a defoaming agent, and a leveling agent.

Optionally, the diluent is butyl acetate.

Optionally, based on a total mass of the resin composition being 100%, a mass percentage of the diluent is 5%-25%, a mass percentage of the defoaming agent is 0.01%-0.5%, and a mass percentage of the leveling agent is 0.01%-0.5%.

In another aspect, provided is an artificial nail, which is obtained by curing the resin composition above, optionally, a Shore hardness of the artificial nail is at least D30.

In another aspect, provided is a method for preparing the artificial nail above, including following steps:
subjecting the resin composition to glue dripping or a printing/coating process to obtain a semi-finished product of the artificial nail; and
curing the semi-finished product of the artificial nail with ultraviolet light to obtain the artificial nail.

In some such preparation methods, after the glue dripping or the printing/coating process, the resin composition is naturally cured at 25-35° C. for 4-8 hours to obtain the semi-finished product of the artificial nail.

In some such preparation methods, a wavelength of the ultraviolet light is 280-425 nm, and a time of ultraviolet light irradiation is 3-60 seconds.

In some such preparation methods, the semi-finished product of the artificial nail has a Shore hardness being at least A20 and less than D30.

### Effects of the Present Disclosure

The artificial nail prepared from the resin composition disclosed herein can be preformed and has a weak foreign body sensation, thereby meeting different needs of users. Moreover, since the resin composition contains two or more resin components, the hardness and softness of the artificial nail can be adjusted by changing types and contents of the resin components.

The method for preparing the artificial nail of the present disclosure is simple and easy to implement. Raw materials of the artificial nail are easy to obtain, and the artificial nail is suitable for mass production.

### DETAILED DESCRIPTION

Various exemplary embodiments, features, and aspects of the disclosure will be described in detail below. The word “exemplary” is used exclusively herein to mean “serving as an example, embodiment, or illustration”. Any example described herein as “exemplary” is not necessarily to be construed as preferred or advantageous over other examples.

In addition, in order to better illustrate the present disclosure, numerous specific details are given in the following specific examples. It should be understood by those skilled in the art that the present disclosure may be enabled without some specific details. In some other examples, methods, means, equipment, and steps well known to those skilled in the art are not described in detail in order to highlight the main purpose of the present disclosure.

Unless otherwise stated, a unit used in this specification is an international standard unit. Furthermore, all numerical values and numerical ranges appearing in the present disclosure should be understood to include a systematic error that is inevitable in industrial production.

In this specification, unless otherwise specified, “%” means percentage by mass.

In this specification, the meaning expressed by “can/may” includes both aspects of performing a certain action and not performing a certain action.

In this specification, terms “some specific/optional/preferred examples”, “other specific/optional/preferred examples”, and “examples” refer to particular elements related to a described example (for example, features, structures, properties, and/or characteristics) that are included in at least one of the examples described herein and may exist in other examples or may not exist in other examples. In addition, it should be understood that the elements may be combined in various examples in any suitable manner.

In this specification, a numerical range expressed using “value A-value B” means a range including endpoints A and B.

### <First Aspect>

The first aspect of the present disclosure provides a resin composition including following components:
a first component including a UV/moisture dual-curable resin, wherein the UV/moisture dual-curable resin has a hydroxyl group;
a second component including a UV curable resin, wherein the UV curable resin has an isocyanate group; and
a photoinitiator.

The inventor of the present disclosure discovers that use of the resin composition of the present disclosure can enable the prepared artificial nail to be preformed and have a weak foreign body sensation, thus meeting different needs of users. Furthermore, since the resin composition includes a first component and a second component, that is, two or more resin components are used to prepare the artificial nail. Therefore, the hardness and softness of the artificial nail can be adjusted by changing types and contents of resin components.

### First Component

The first component of the present disclosure includes a UV/moisture dual-curable resin, wherein the UV/moisture dual-curable resin has a hydroxyl group. Specifically, a hydroxyl value of the first component is 52-110 mgKOH/g, for example: 55 mgKOH/g, 60 mgKOH/g, 65 mgKOH/g, 70 mgKOH/g, 75 mgKOH/g, 80 mgKOH/g, 85 mgKOH/g, 90 mgKOH/g, 95 gKOH/g, 100 gKOH/g, 105 gKOH/g, etc.

The UV/moisture dual-curable resin may be one or a combination of two or more of the following: UV curable polyurethane acrylate resin DS5246 produced by Guangzhou Disheng New Materials Co., Ltd., polyurethane resin B-6014B produced by Guangzhou Bossin Novel Materials Technology Co., Ltd., or aliphatic polyurethane acrylate resin EBECRYL® 8210 produced by Allnex Resins (China) Co., Ltd. The UV/moisture dual-curable resin above has a hydroxyl value of 52-110 mgKOH/g.

In some specific examples, based on a total mass of the resin composition being 100%, a content of the first component is 25%-65%, for example: 28%, 30%, 32%, 35%, 38%, 40%, 42%, 45%, 48%, 50%, 52%, 55%, 58%, 60%, 62%, etc. When the content of the first component is 25%-65%, the effect of the UV/moisture dual-curable resin can be effectively exerted, and the hardness and softness of the artificial nail can be adjusted by changing the content of the UV/moisture dual-curable resin in the resin composition.

### Second Component

The second component of the present disclosure includes a UV curable resin, wherein the UV curable resin has an isocyanate group.

Specifically, the UV curable resin may be one or a combination of two or more of polyurethane acrylates containing an isocyanate group, such as polyurethane acrylate BECRYL® 4150 produced by Allnex Resins (China) Co., Ltd., polyurethane acrylate B-405 produced by Guangzhou Bossin Novel Materials Technology Co., Ltd., or polyurethane acrylate SR-2345 produced by Guangzhou Haoyi New Material Technology Co., Ltd.

In some specific examples, based on a total mass of the resin composition being 100%, the content of the second component is 15%-45%, for example: 18%, 20%, 22%, 25%, 28%, 30%, 32%, 35%, 38%, 40%, 42%, etc. When the content of the second component is 15%-45%, the effect of the UV curable resin can be effectively exerted.

In the present disclosure, it may enable the prepared artificial nail to be preformed and have a weak foreign body sensation by using a combination of the first component and the second component.

### Third Component

In the present disclosure, the resin composition may further include a third component, and the third component includes a polycaprolactone polyol. In the present disclosure, the hardness and softness of the artificial nail can be further adjusted by using the third component.

Specifically, the polycaprolactone polyol of the present disclosure may be polycaprolactone diol, polycaprolactone triol, or the like. Furthermore, a hydroxyl value of the polycaprolactone polyol is 54-98 mgKOH/g, for example: 58 mgKOH/g, 60 mgKOH/g, 62 mgKOH/g, 65 mgKOH/g, 68 mgKOH/g, 70 mgKOH/g, 72 mgKOH/g, 75 mgKOH/g, 78 mgKOH/g, 80 mgKOH/g, 82 mgKOH/g, 85 mgKOH/g, 88 mgKOH/g, 90 mgKOH/g, 92 mgKOH/g, 95 mgKOH/g, etc.

In some specific examples, based on the total mass of the resin composition being 100%, the content of the third component is 5%-30%, for example: 8%, 10%, 12%, 15%, 18%, 20%, 22%, 25%, 28%, etc. When the content of the third component is 5%-30%, the function of the polycaprolactone polyol can be effectively exerted, and the hardness and softness of the artificial nail can be further adjusted by changing the content of the polycaprolactone polyol.

Specifically, the polycaprolactone polyol may be one or a combination of two of polycaprolactone polyol PCL-2202 produced by Chengdu Juren Chemical Industry Co., Ltd. or polycaprolactone polyol Capa2201 produced by PERSTORP.

### Photoinitiator

A photoinitiator is also included in the resin composition of the present disclosure. The photoinitiator refers to a compound that decomposes upon irradiation with active energy rays such as ultraviolet light or visible light to generate radical active species, cationic active species, or anionic active species. The photoinitiator is not particularly limited and may be a commonly used photoinitiator such as a free radical photoinitiator.

Specifically, the free radical photoinitiator may include but is not limited to one or a combination of two or more of the following: 1-hydroxycyclohexylphenyl ketone (photoinitiator 184), diethoxyacetophenone, 2-hydroxy-2-methyl-1-phenylpropane-1-one, benzyl dimethyl ketal, 4-(2-hydroxyethoxy)phenyl-(2-hydroxy-2-propyl)ketone, 2-methyl-2-morpholino(4-thiomethylphenyl)propane-1-one, 2-benzyl-2-dimethylamino-1-(4-morpholinophenyl)butanone, oligo[2-hydroxy-2-methyl-1-[4-(1-methylvinyl)phenyl]propanone], benzoin, benzoin methyl ether, benzoin ethyl ether, benzoin isopropyl ether, benzoin isobutyl ether, benzophenone, methyl o-benzoylbenzoate, 4-phenylbenzophenone, 4-benzoyl-4′-methyldiphenyl sulfide, 3,3′,4,4′-tetrakis(tert-butylperoxycarbonyl)benzophenone, 2,4,6-trimethylbenzophenone, 4-benzoyl-N,N-dimethyl-N-[2-(1-oxo-2-propenyloxy)ethyl]benzylamine bromide, (4-benzoylbenzyl)trimethylammonium chloride, 2-isopropylthioxanthone, 4-isopropylthioxanthone, 2,4-diethylthioxanthone, 2,4-dichlorothioxanthone, 1-chloro-4-propoxythioxanthone, 2-(3-dimethylamino-2-hydroxy)-3,4-dimethyl-9H-thioxanthone-9-one meso chloride, 2,4,6-trimethyl benzoyl diphenyl phosphine oxide (photoinitiator TPO), bis(2,4,6-trimethylbenzoyl)-phenylphosphine oxide (photoinitiator 819), acylphosphine oxides, etc.

In some specific examples, in order to more effective achieve the effects of the present disclosure, an amount of the photoinitiator added is 2-5 wt %, for example: 2.5 wt %, 3 wt %, 3.5 wt %, 4 wt %, 4.5 wt %, etc.

Specifically, the photoinitiator disclosed herein may be one or a combination of two or more of photoinitiator 184, photoinitiator TPO, or photoinitiator 819.

### Diluent

The resin composition of the present disclosure may optionally include a diluent. In the present disclosure, fluidity of the resin composition can be increased by adding a diluent. The diluent disclosed herein may completely volatilize during processing, and raw materials may be in a film-like state after volatilization of the diluent. Therefore, the resin composition of the present disclosure may contain a certain amount of a diluent. The diluent disclosed herein is not particularly limited, and those skilled in the art can make a conventional selection based on their needs.

The diluent may include one or a combination of two or more of toluene, xylene, trimethylbenzene, ethanol, butyl acetate, etc. Furthermore, in order to effectively exert the effect of the diluent disclosed herein, butyl acetate is preferably used as the diluent.

In some specific examples, in order to more effective achieve the effects of the present disclosure, a content of the diluent is 5%-25%, for example: 7%, 9%, 11%, 13%, 15%, 17%, 19%, 21%, 23%, etc., based on a total mass of the resin composition being 100%.

In the present disclosure, when a printing/coating process is adopted, the resin composition can be diluted to 300-2000 mPa·s using a diluent; when a glue dripping process is adopted, the resin composition can be diluted to 3000-5000 mPa·s using a diluent.

### Other Components

The resin composition of the present disclosure may also contain other components. In addition to the above-mentioned components, additives such as a defoaming agent, a pigment, a homogenizing agent, a dispersant, and a leveling agent may be used in the present disclosure within a scope not impairing the purpose of the present disclosure.

For the defoaming agent, a content of the defoaming agent is 0.01%-0.5%, for example: 0.05%, 0.1%, 0.15%, 0.2%, 0.25%, 0.3%, 0.35%, 0.4%, 0.45%, etc., based on a total mass of the resin composition being 100%. In the present disclosure, the defoaming agent preferably does not contain organosilicone. Specifically, the defoaming agent may be defoaming agent tego920, defoaming agent tego923, defoaming agent byk057, etc.

The leveling agent may be an organic silicon compound. Furthermore, based on a total mass of the resin composition being 100%, a content of the leveling agent is 0.01%-0.5%, for example: 0.05%, 0.1%, 0.15%, 0.2%, 0.25%, 0.3%, 0.35%, 0.4%, 0.45%, etc. Specifically, the leveling agent may be siloxane polyether copolymer (tego450), siloxane polyether copolymer (tego270), polyether modified polydimethylsiloxane (BYK333), etc.

Furthermore, the first aspect of the present disclosure also provides a method for preparing a resin composition, including a step of mixing the components of the resin composition. The mixing can generally be carried out at room temperature.

### <Second Aspect>

The second aspect of the present disclosure provides an artificial nail, which is obtained by curing the resin composition in the first aspect of the present disclosure. Optionally, a Shore hardness of the artificial nail is at least D30.

The artificial nail disclosed herein can be preformed during the preparation process, and a finally obtained artificial nail has a weak foreign body sensation.

The present disclosure also provides a method for preparing the artificial nail according to the present disclosure, including following steps:
subjecting the resin composition to glue dripping or a printing/coating process to obtain a semi-finished product of the artificial nail; and
curing the semi-finished product of the artificial nail with ultraviolet light to obtain the artificial nail.

In some specific examples, the above substances (i.e., components of the resin composition) are mixed and stirred evenly to obtain a resin composition, which is then subjected to glue dripping or a printing/coating process, and naturally cured at a temperature of 25-35° C. for 4-8 hours to obtain a semi-finished product of the artificial nail. By controlling the temperature and curing time, the hardness of the semi-finished product of the artificial nail can be further adjusted. Generally speaking, in the present disclosure, a Shore hardness of the semi-finished product of the artificial nail is at least A20 and less than D30.

In some specific examples, a wavelength of the ultraviolet light is 280-425 nm; and a time of ultraviolet light irradiation is 3-60 seconds. The semi-finished product of the artificial nail of the present disclosure may be formed into the artificial nail by ultraviolet light irradiation.

Specifically, in the present disclosure, in addition to adjusting components of the resin composition, the type and content of the resin components, etc. to control the hardness and softness of the artificial nail, the hardness and softness of a final artificial nail may also be controlled by changing the time of ultraviolet light irradiation, thereby further meeting preference requirements of users.

### EXAMPLES

The examples of the present disclosure will be described in detail with reference to examples. However, those skilled in the art should understand that following examples are only used to illustrate the present disclosure and should not be considered as limitation of the scope of the present disclosure. If no specific conditions are specified in the examples, methods in examples shall be carried out according to conventional conditions or conditions recommended by manufacturers. Reagents or instruments used without indicating manufacturers are all common products available on the market.

### Example 1

15 kg of butyl acetate and 55 kg of UV curable polyurethane acrylate resin DS5246 with a hydroxyl value of 52 mgKOH/g produced by Guangzhou Disheng New Materials Co., Ltd. were mixed and stirred evenly. A resulting mixture was added to a container containing 25 kg of polyurethane acrylate BECRYL® 4150 (having an isocyanate group content of 12%) produced by Allnex Resins (China) Co., Ltd. Then 4.8 kg of photoinitiator 184, 0.1 kg of defoaming agent tego920, and 0.1 kg of leveling agent BYK333 were added into the container. At room temperature, the above substances (i.e., components of the resin composition) were mixed and stirred evenly to obtain a resin composition.

### Example 2

15 kg of butyl acetate and 53 kg of UV curable polyurethane acrylate resin DS5246 with a hydroxyl value of 52 mgKOH/g produced by Guangzhou Disheng New Materials Co., Ltd. were mixed and stirred evenly. A resulting mixture was added to a container containing 27 kg of polyurethane acrylate BECRYL® 4150 (having an isocyanate group content of 12%) produced by Allnex Resins (China) Co., Ltd. Then 4.8 kg of photoinitiator diphenyl(2,4,6-trimethylbenzoyl) phosphine oxide (TPO), 0.1 kg of defoaming agent tego920, and 0.1 kg of leveling agent BYK333 were added into the container. At room temperature, the above substances (i.e., components of the resin composition) were mixed and stirred evenly to obtain a resin composition.

### Example 3

15 kg of butyl acetate and 50 kg of UV curable polyurethane acrylate resin DS5246 with a hydroxyl value of 52 mgKOH/g produced by Guangzhou Disheng New Materials Co., Ltd. were mixed and stirred evenly. A resulting mixture was added to a container containing 30 kg of polyurethane acrylate BECRYL® 4150 (having an isocyanate group content of 12%) produced by Allnex Resins (China) Co., Ltd. Then 4.8 kg of a photoinitiator (consisting of 1.8 kg of photoinitiator 184 and 3 kg of photoinitiator TPO), 0.1 kg of defoaming agent tego920, and 0.1 kg of leveling agent BYK333 were added into the container. At room temperature, the above substances (i.e., components of the resin composition) were mixed and stirred evenly to obtain a resin composition.

### Example 4

15 kg of butyl acetate and 48 kg of UV curable polyurethane acrylate resin DS5246 with a hydroxyl value of 52 mgKOH/g produced by Guangzhou Disheng New Materials Co., Ltd. were mixed and stirred evenly. A resulting mixture was added to a container containing 32 kg of polyurethane acrylate BECRYL® 4150 (having an isocyanate group content of 12%) produced by Allnex Resins (China) Co., Ltd. Then 4.5 kg of photoinitiator 819, 0.25 kg of defoaming agent tego920, and 0.25 kg of leveling agent BYK333 were added into the container. At room temperature, the above substances (i.e., components of the resin composition) were mixed and stirred evenly to obtain a resin composition.

### Example 5

15 kg of butyl acetate and 45 kg of UV curable polyurethane acrylate resin DS5246 with a hydroxyl value of 52 mgKOH/g produced by Guangzhou Disheng New Materials Co., Ltd. were mixed and stirred evenly. A resulting mixture was added to a container containing 35 kg of polyurethane acrylate BECRYL® 4150 (having an isocyanate group content of 12%) produced by Allnex Resins (China) Co., Ltd. Then 4.5 kg of a photoinitiator (consisting of 1.5 kg of photoinitiator 184 and 3 kg of photoinitiator 819), 0.25 kg of defoaming agent tego920, and 0.25 kg of leveling agent BYK333 were added into the container. At room temperature, the above substances (i.e., components of the resin composition) were mixed and stirred evenly to obtain a resin composition.

### Example 6

10 kg of butyl acetate and 65 kg of UV curable polyurethane resin B-6014B with a hydroxyl value of 78 mgKOH/g produced by Guangzhou Bossin Novel Materials Technology Co., Ltd. were mixed and stirred evenly. A resulting mixture was added to a container containing 20 kg of polyurethane acrylate B-405 (having an isocyanate group content of 12.8%) produced by Guangzhou Bossin Novel Materials Technology Co., Ltd. Then 4.5 kg of a photoinitiator (consisting of 1.5 kg of photoinitiator 184 and 3 kg of photoinitiator 819), 0.25 kg of defoaming agent tego920, and 0.25 kg of leveling agent BYK333 were added into the container. At room temperature, the above substances (i.e., components of the resin composition) were mixed and stirred evenly to obtain a resin composition.

### Example 7

10 kg of butyl acetate and 63 kg of UV curable polyurethane resin B-6014B with a hydroxyl value of 78 mgKOH/g produced by Guangzhou Bossin Novel Materials Technology Co., Ltd. were mixed and stirred evenly. A resulting mixture was added to a container containing 22 kg of polyurethane acrylate B-405 (having an isocyanate group content of 12.8%) produced by Guangzhou Bossin Novel Materials Technology Co., Ltd. Then 4.5 kg of a photoinitiator (consisting of 1.5 kg of photoinitiator 184 and 3 kg of photoinitiator 819), 0.25 kg of defoaming agent tego920, and 0.25 kg of leveling agent BYK333 were added into the container. At room temperature, the above substances (i.e., components of the resin composition) were mixed and stirred evenly to obtain a resin composition.

### Example 8

10 kg of butyl acetate and 60 kg of UV curable polyurethane resin B-6014B with a hydroxyl value of 78 mgKOH/g produced by Guangzhou Bossin Novel Materials Technology Co., Ltd. were mixed and stirred evenly. A resulting mixture was added to a container containing 25 kg of polyurethane acrylate B-405 (having an isocyanate group content of 12.8%) produced by Guangzhou Bossin Novel Materials Technology Co., Ltd. Then 4.5 kg of a photoinitiator (consisting of 1.5 kg of photoinitiator 184 and 3 kg of photoinitiator 819), 0.25 kg of defoaming agent tego920, and 0.25 kg of leveling agent BYK333 were added into the container. At room temperature, the above substances (i.e., components of the resin composition) were mixed and stirred evenly to obtain a resin composition.

### Example 9

10 kg of butyl acetate and 57 kg of UV curable polyurethane resin B-6014B with a hydroxyl value of 78 mgKOH/g produced by Guangzhou Bossin Novel Materials Technology Co., Ltd. were mixed and stirred evenly. A resulting mixture was added to a container containing 28 kg of polyurethane acrylate B-405 (having an isocyanate group content of 12.8%) produced by Guangzhou Bossin Novel Materials Technology Co., Ltd. Then 4.5 kg of a photoinitiator (consisting of 1.5 kg of photoinitiator 184 and 3 kg of photoinitiator 819), 0.25 kg of defoaming agent tego920, and 0.25 kg of leveling agent BYK333 were added into the container. At room temperature, the above substances (i.e., components of the resin composition) were mixed and stirred evenly to obtain a resin composition.

### Example 10

10 kg of butyl acetate and 50 kg of UV curable polyurethane resin B-6014B with a hydroxyl value of 78 mgKOH/g produced by Guangzhou Bossin Novel Materials Technology Co., Ltd. were mixed and stirred evenly. A resulting mixture was added to a container containing 35 kg of polyurethane acrylate B-405 (having an isocyanate group content of 12.8%) produced by Guangzhou Bossin Novel Materials Technology Co., Ltd. Then 4.5 kg of a photoinitiator (consisting of 1.5 kg of photoinitiator 184 and 3 kg of photoinitiator 819), 0.25 kg of defoaming agent tego920, and 0.25 kg of leveling agent BYK333 were added into the container. At room temperature, the above substances (i.e., components of the resin composition) were mixed and stirred evenly to obtain a resin composition.

### Application Examples

Each resin composition prepared in Examples 1-10 was coated on a release film using a coating tester respectively, and then naturally cured at a temperature of about 30° C. for a certain time as shown in Table 1 below to obtain a semi-finished product of an artificial nail. The semi-finished product of the artificial nail was then irradiated with ultraviolet light having a wavelength of 370 nm for a certain time as shown in Table 1 below, thereby obtaining an artificial nail. Then, the semi-finished products of artificial nails and the artificial nails were tested according to the Shore hardness test method specified in GB/T 531-1999. The results are shown in Table 1 below.

TABLE 1

| | Item | | | | | | |
|---|---|---|---|---|---|---|---|
| | Hardness | Hardness | Hardness | Hardness | Hardness | Hardness | Hardness |
| | of a semi- | of a semi- | of a semi- | of an | of an | of an | of an |
| | finished | finished | finished | artificial | artificial | artificial | artificial |
| | product | product | product | nail | nail | nail | nail |
| | (natural | (natural | (natural | (irradiating | (irradiating | (irradiating | (irradiating |
| | curing for | curing for | curing for | for 5 | for 15 | for 30 | for 60 |
| Example | 4 h) | 6 h) | 8 h) | seconds) | seconds) | seconds) | seconds) |
| Example 1 | A26 | A31 | A39 | D45 | D48 | D53 | D55 |
| Example 2 | A27 | A31 | A40 | D45 | D48 | D53 | D55 |
| Example 3 | A27 | A32 | A40 | D48 | D49 | D55 | D56 |
| Example 4 | A29 | A34 | A43 | D49 | D51 | D55 | D58 |
| Example 5 | A30 | A34 | A44 | D50 | D51 | D56 | D60 |
| Example 6 | A26 | A30 | A39 | D45 | D47 | D52 | D55 |
| Example 7 | A26 | A31 | A40 | D46 | D48 | D53 | D55 |
| Example 8 | A28 | A32 | A42 | D48 | D48 | D55 | D57 |
| Example 9 | A29 | A34 | A43 | D50 | D50 | D56 | D58 |
| Example | A30 | A35 | A45 | D50 | D51 | D56 | D59 |
| 10 | | | | | | | |

As can be seen from Table 1, the artificial nails prepared in Examples 1-10 of the present disclosure have lower hardness and softer texture as the content of the UV/moisture dual-curable resin containing a hydroxyl group increases. However, the hardness of the artificial nails obtained after being irradiated with ultraviolet light are higher. Thus, the hardness and softness of the artificial nail of the present disclosure can be adjusted by changing the types and contents of resin components to meet the needs of users.

Furthermore, as the time of natural curing increases, the hardness of the semi-finished product of the artificial nail will increase and its texture will become harder. As the UV light exposure time increases, the hardness of the artificial nail will increase and its texture will become harder. Therefore, the hardness and softness of artificial nails can be further adjusted to meet user needs by controlling the time of natural curing and ultraviolet light irradiation.

### Example 11

5 kg of polycaprolactone polyol PCL-2202 with a hydroxyl value of 56 mgKOH/g produced by Chengdu Juren Chemical Industry Co., Ltd. and 10 kg of butyl acetate were mixed and stirred evenly. A resulting mixture was added into a container containing 55 kg of UV curable polyurethane acrylate resin DS5246 having a hydroxyl value of 52 mgKOH/g produced by Guangzhou Disheng New Materials Co., Ltd. and further stirred evenly. 25 kg of polyurethane acrylate BECRYL® 4150 with an isocyanate group content of 12% produced by Allnex Resins (China) Co., Ltd. was further added to the container, and finally 4.5 kg of photoinitiator 184, 0.25 kg of defoaming agent tego920, and 0.25 kg of leveling agent BYK333 were added to the container.

At room temperature, the above substances (i.e., components of the resin composition) were mixed and stirred evenly to obtain a resin composition.

### Example 12

8 kg of polycaprolactone polyol PCL-2202 with a hydroxyl value of 56 mgKOH/g produced by Chengdu Juren Chemical Industry Co., Ltd. and 10 kg of butyl acetate were mixed and stirred evenly. A resulting mixture was added into a container containing 52 kg of UV curable polyurethane acrylate resin DS5246 having a hydroxyl value of 52 mgKOH/g produced by Guangzhou Disheng New Materials Co., Ltd. and further stirred evenly. 25 kg of polyurethane acrylate BECRYL® 4150 with an isocyanate group content of 12% produced by Allnex Resins (China) Co., Ltd. was further added to the container, and finally 4.5 kg of photoinitiator TPO, 0.25 kg of defoaming agent tego920, and 0.25 kg of leveling agent BYK333 were added to the container. At room temperature, the above substances (i.e., components of the resin composition) were mixed and stirred evenly to obtain a resin composition.

### Example 13

10 kg of polycaprolactone polyol PCL-2202 with a hydroxyl value of 56 mgKOH/g produced by Chengdu Juren Chemical Industry Co., Ltd. and 10 kg of butyl acetate were mixed and stirred evenly. A resulting mixture was added into a container containing 50 kg of UV curable polyurethane acrylate resin DS5246 having a hydroxyl value of 52 mgKOH/g produced by Guangzhou Disheng New Materials Co., Ltd. and further stirred evenly. 25 kg of polyurethane acrylate BECRYL® 4150 with an isocyanate group content of 12% produced by Allnex Resins (China) Co., Ltd. was further added to the container, and finally 4.5 kg of a photoinitiator (consisting of 1.5 kg of photoinitiator 184 and 3 kg of photoinitiator TPO), 0.25 kg of defoaming agent tego920, and 0.25 kg of leveling agent BYK333 were added to the container. At room temperature, the above substances (i.e., components of the resin composition) were mixed and stirred evenly to obtain a resin composition.

### Example 14

13 kg of polycaprolactone polyol PCL-2202 with a hydroxyl value of 56 mgKOH/g produced by Chengdu Juren Chemical Industry Co., Ltd. and 10 kg of butyl acetate were mixed and stirred evenly. A resulting mixture was added into a container containing 48 kg of UV curable polyurethane acrylate resin DS5246 having a hydroxyl value of 52 mgKOH/g produced by Guangzhou Disheng New Materials Co., Ltd. and further stirred evenly. 25 kg of polyurethane acrylate BECRYL® 4150 with an isocyanate group content of 12% produced by Allnex Resins (China) Co., Ltd. was further added to the container, and finally 3.5 kg of photoinitiator 819, 0.25 kg of defoaming agent tego920, and 0.25 kg of leveling agent BYK333 were added to the container. At room temperature, the above substances (i.e., components of the resin composition) were mixed and stirred evenly to obtain a resin composition.

### Example 15

15 kg of polycaprolactone polyol PCL-2202 with a hydroxyl value of 56 mgKOH/g produced by Chengdu Juren Chemical Industry Co., Ltd. and 10 kg of butyl acetate were mixed and stirred evenly. A resulting mixture was added into a container containing 45 kg of UV curable polyurethane acrylate resin DS5246 having a hydroxyl value of 52 mgKOH/g produced by Guangzhou Disheng New Materials Co., Ltd. and further stirred evenly. 25 kg of polyurethane acrylate BECRYL® 4150 with an isocyanate group content of 12% produced by Allnex Resins (China) Co., Ltd. was further added to the container, and finally 4.5 kg of photoinitiator (consisting of 1.5 kg of photoinitiator 184 and 3 kg of photoinitiator 819), 0.25 kg of defoaming agent tego920, and 0.25 kg of leveling agent BYK333 were added to the container. At room temperature, the above substances (i.e., components of the resin composition) were mixed and stirred evenly to obtain a resin composition.

### Example 16

18 kg of polycaprolactone polyol Capa2201 with a hydroxyl value of 56 mgKOH/g produced by PERSTORP and 15 kg of butyl acetate were mixed and stirred evenly. A resulting mixture was added into a container containing 45 kg of UV curable polyurethane resin B-6014B having a hydroxyl value of 78 mgKOH/g produced by Guangzhou Bossin Novel Materials Technology Co., Ltd. and further stirred evenly. 18 kg of polyurethane acrylate B-405 with an isocyanate group content of 12.8% produced by Guangzhou Bossin Novel Materials Technology Co., Ltd. was further added to the container, and finally 3.5 kg of a photoinitiator (consisting of 1 kg of photoinitiator 184 and 2.5 kg of photoinitiator 819), 0.25 kg of defoaming agent tego920, and 0.25 kg of leveling agent BYK333 were added to the container. At room temperature, the above substances (i.e., components of the resin composition) were mixed and stirred evenly to obtain a resin composition.

### Example 17

20 kg of polycaprolactone polyol Capa2201 with a hydroxyl value of 56 mgKOH/g produced by PERSTORP and 15 kg of butyl acetate were mixed and stirred evenly. A resulting mixture was added into a container containing 42 kg of UV curable polyurethane resin B-6014B having a hydroxyl value of 78 mgKOH/g produced by Guangzhou Bossin Novel Materials Technology Co., Ltd. and further stirred evenly. 18 kg of polyurethane acrylate B-405 with an isocyanate group content of 12.8% produced by Guangzhou Bossin Novel Materials Technology Co., Ltd. was further added to the container, and finally 4.5 kg of a photoinitiator (consisting of 1.5 kg of photoinitiator 184 and 3 kg of photoinitiator 819), 0.25 kg of defoaming agent tego920, and 0.25 kg of leveling agent BYK333 were added to the container. At room temperature, the above substances (i.e., components of the resin composition) were mixed and stirred evenly to obtain a resin composition.

### Example 18

23 kg of polycaprolactone polyol Capa2201 with a hydroxyl value of 56 mgKOH/g produced by PERSTORP and 15 kg of butyl acetate were mixed and stirred evenly. A resulting mixture was added into a container containing 40 kg of UV curable polyurethane resin B-6014B having a hydroxyl value of 78 mgKOH/g produced by Guangzhou Bossin Novel Materials Technology Co., Ltd. and further stirred evenly. 18 kg of polyurethane acrylate B-405 with an isocyanate group content of 12.8% produced by Guangzhou Bossin Novel Materials Technology Co., Ltd. was further added to the container, and finally 3.8 kg of a photoinitiator (consisting of 1.5 kg of photoinitiator 184 and 2.3 kg of photoinitiator 819), 0.1 kg of defoaming agent tego920, and 0.1 kg of leveling agent BYK333 were added to the container. At room temperature, the above substances (i.e., components of the resin composition) were mixed and stirred evenly to obtain a resin composition.

### Example 19

25 kg of polycaprolactone polyol Capa2201 with a hydroxyl value of 56 mgKOH/g produced by PERSTORP and 17 kg of butyl acetate were mixed and stirred evenly. A resulting mixture was added into a container containing 35 kg of UV curable polyurethane resin B-6014B having a hydroxyl value of 78 mgKOH/g produced by Guangzhou Bossin Novel Materials Technology Co., Ltd. and further stirred evenly. 18 kg of polyurethane acrylate B-405 with an isocyanate group content of 12.8% produced by Guangzhou Bossin Novel Materials Technology Co., Ltd. was further added to the container, and finally 4.5 kg of a photoinitiator (consisting of 1.5 kg of photoinitiator 184 and 3 kg of photoinitiator 819), 0.25 kg of defoaming agent tego920, and 0.25 kg of leveling agent BYK333 were added to the container. At room temperature, the above substances (i.e., components of the resin composition) were mixed and stirred evenly to obtain a resin composition.

### Example 20

27 kg of polycaprolactone polyol Capa2201 with a hydroxyl value of 56 mgKOH/g produced by PERSTORP and 15 kg of butyl acetate were mixed and stirred evenly. A resulting mixture was added into a container containing 35 kg of UV curable polyurethane resin B-6014B having a hydroxyl value of 78 mgKOH/g produced by Guangzhou Bossin Novel Materials Technology Co., Ltd. and further stirred evenly. 18 kg of polyurethane acrylate B-405 with an isocyanate group content of 12.80 produced by Guangzhou Bossin Novel Materials Technology Co., Ltd. was further added to the container, and finally 4.5 kg of a photoinitiator (consisting of 1.5 kg of photoinitiator 184 and 3 kg of photoinitiator 819), 0.25 kg of defoaming agent tego920, and 0.25 kg of leveling agent BYK333 were added to the container. At room temperature, the above substances (i.e., components of the resin composition) were mixed and stirred evenly to obtain a resin composition.

### Application Examples

Each resin composition prepared in Examples 11-20 was coated on a release film using a coating tester respectively, and then naturally cured at a temperature of about 30° C. for a certain time as shown in Table 2 below to obtain a semi-finished product of an artificial nail. The semi-finished product of the artificial nail was then irradiated with ultraviolet light having a wavelength of 370 nm according to the time in Table 2 below, thereby obtaining an artificial nail. Then, the semi-finished products of artificial nails and the artificial nails were tested according to the Shore hardness test method specified in GB/T 531-1999. The results are shown in Table 2 below.

TABLE 2

| | Item | | | | | | |
|---|---|---|---|---|---|---|---|
| | Hardness | Hardness | Hardness | Hardness | Hardness | Hardness | Hardness |
| | of a semi- | of a semi- | of a semi- | of an | of an | of an | of an |
| | finished | finished | finished | artificial | artificial | artificial | artificial |
| | product | product | product | nail | nail | nail | nail |
| | (natural | (natural | (natural | (irradiating | (irradiating | (irradiating | (irradiating |
| | drying for | drying for | drying for | for 5 | for 15 | for 30 | for 60 |
| Example | 4 h) | 6 h) | 8 h) | seconds) | seconds) | seconds) | seconds) |
| Example | A33 | A42 | A55 | D38 | D46 | D51 | D53 |
| 11 | | | | | | | |
| Example | A31 | A40 | A54 | D37 | D43 | D50 | D51 |
| 12 | | | | | | | |
| Example | A30 | A41 | A51 | D34 | D42 | D50 | D50 |
| 13 | | | | | | | |
| Example | A28 | A37 | A49 | D33 | D40 | D49 | D49 |
| 14 | | | | | | | |
| Example | A25 | A33 | A43 | D30 | D37 | D48 | D49 |
| 15 | | | | | | | |
| Example | A30 | A35 | A43 | D41 | D53 | D60 | D65 |
| 16 | | | | | | | |
| Example | A30 | A34 | A41 | D40 | D53 | D59 | D63 |
| 17 | | | | | | | |
| Example | A28 | A31 | A41 | D40 | D51 | D59 | D63 |
| 18 | | | | | | | |
| Example | A25 | A31 | A39 | D38 | D49 | D57 | D61 |
| 19 | | | | | | | |
| Example | A21 | A29 | A37 | D36 | D47 | D57 | D60 |
| 20 | | | | | | | |

As can be seen from Table 2 and Examples 11-15, when polycaprolactone polyol PCL-2202 having a hydroxyl value of 56 mgKOH/g produced by Chengdu Juren Chemical Industry Co., Ltd. is used in the resin composition to prepare a semi-finished product of an artificial nail, the artificial nail becomes softer as the amount of a polycaprolactone polyol used increases; and the softness of artificial nails can be well controlled by regulating UV exposure time.

As can be seen from Examples 16-20, when polycaprolactone polyol Capa2201 having a hydroxyl value of 56 mgKOH/g produced by PERSTORP is used in the resin composition to prepare a semi-finished product of an artificial nail, the artificial nail also becomes softer as the amount of a polycaprolactone polyol used increases; and the softness of artificial nails can be well controlled by regulating UV exposure time.

Therefore, it can be seen from Examples 11-20 that artificial nails with different hardness can be prepared by reasonably adjusting a formula of the resin composition of the present disclosure. In the present disclosure, the softness of an artificial nail can also be adjusted by changing the irradiating time of the semi-finished product of the artificial nail to meet the needs of different people for different nail types.

The above examples disclosed herein are provided merely to clearly illustrate the embodiments of this disclosure, and are not intended to limit the scope of this disclosure. For ordinary technicians in the art, other different forms of changes or modifications can be made based on the above description. It is neither necessary nor possible to exhaustively enumerate all embodiments here. Any modifications, equivalent substitutions and improvements made within the spirit and principles of this disclosure should be included in the scope of the claims of this disclosure.

1. A resin composition comprising following components:
a first component comprising a UV/moisture dual-curable resin, wherein the UV/moisture dual-curable resin has a hydroxyl group;
a second component comprising a UV curable resin, wherein the UV curable resin has an isocyanate group; and
a photoinitiator.

2. The resin composition of claim 1, wherein a hydroxyl value of the first component is 52-110 mgKOH/g; and/or
wherein a mass percentage of the isocyanate group in the second component is 11.8%-13.8%.

3. The resin composition of claim 1, wherein, based on a total mass of the resin composition being 100%, a mass percentage of the first component is 25%-65%, a mass percentage of the second component is 15%-45%, and a mass percentage of the photoinitiator is 2%-5%.

4. The resin composition of claim 1, further comprising a third component, wherein the third component comprises a polycaprolactone polyol.

5. The resin composition of claim 4, wherein a hydroxyl value of the polycaprolactone polyol is 54-98 mgKOH/g.

6. The resin composition of claim 4, wherein, based on a total mass of the resin composition being 100%, a mass percentage of the polycaprolactone polyol is 5%-30%.

7. The resin composition of claim 1, further comprising one or a combination of two or more of the group consisting of a diluent, a defoaming agent, and a leveling agent.

8. The resin composition of claim 7, wherein the diluent is butyl acetate.

9. The resin composition of claim 7, wherein, based on a total mass of the resin composition being 100%, a mass percentage of the diluent is 5%-25%, a mass percentage of the defoaming agent is 0.01%-0.5%, and a mass percentage of the leveling agent is 0.01%-0.5%.

10. The resin composition of claim 4, wherein a hydroxyl value of the polycaprolactone polyol is 54-98 mgKOH/g,
wherein, based on a total mass of the resin composition being 100%, a mass percentage of the polycaprolactone polyol is 5%-30%,
the resin composition further comprises a diluent, a defoaming agent, and a leveling agent,
wherein, based on a total mass of the resin composition being 100%, a mass percentage of the diluent is 5%-25%, a mass percentage of the defoaming agent is 0.01%-0.5%, and a mass percentage of the leveling agent is 0.01%-0.5%, and
wherein the diluent is butyl acetate.

11. An artificial nail obtained by curing the resin composition of claim 1.

12. The artificial nail of claim 11, wherein a Shore hardness of the artificial nail is at least D30.

13. An artificial nail obtained by curing the resin composition of claim 2.

14. An artificial nail obtained by curing the resin composition of claim 3.

15. An artificial nail obtained by curing the resin composition of claim 6.

16. An artificial nail obtained by curing the resin composition of claim 10.

17. A method for preparing the artificial nail of claim 13, comprising following steps:
subjecting the resin composition to glue dripping or a printing/coating process to obtain a semi-finished product of the artificial nail; and
curing the semi-finished product of the artificial nail with ultraviolet light to obtain the artificial nail.

18. The method of claim 17, wherein, after the glue dripping or the printing/coating process, the resin composition is naturally cured at 25-35° C. for 4-8 hours to obtain the semi-finished product of the artificial nail.

19. The method of claim 17, wherein a wavelength of the ultraviolet light is 280-425 nm, and a time of ultraviolet light irradiation is 3-60 seconds.

20. The method of claim 17, wherein the semi-finished product of the artificial nail has a Shore hardness being at least A20 and less than D30.
